(19) United States
(12) Patent Application Publication
(10) Pub. No.: US 2012/0009087 A1
(43) Pub. Date: Jan. 12, 2012

(54) SAMPLE PROCESSING APPARATUS AND SAMPLE TRANSPORTING DEVICE

(76) Inventor: Koichi Okubo, Kobe-shi (JP)

(21) Appl. No.: 13/176,148

(22) Filed: Jul. 5, 2011

(30) Foreign Application Priority Data
Jul. 9, 2010 (JP) 2010-157178

(51) Int. Cl. G01N 35/10

(52) U.S. Cl. 422/63

(57) ABSTRACT

The present invention provides a sample transporting device for transporting a sample container based on transport control information received from a transport control unit. The sample transporting device includes: a controller configured to control a transport operation of the sample transporting device in response to transport control information received from the transport control unit; and a repeater connected to a first cable and a second cable, configured to receive the transport control information from the transport control unit through the first cable, and relay the transport control information to the controller when the received transport control information specifies the sample transporting device, or relay the transport control information to the second cable when the received transport control information specifies another sample transporting device.

### RELATED APPLICATIONS

This application claims priority under 35 U.S.C. §119 to Japanese Patent Application No. 2010-157178 filed on Jul. 9, 2010, the entire content of which is hereby incorporated by reference.

### BACKGROUND OF THE INVENTION

1. Field of the Invention

The present invention relates to a sample processing apparatus for processing a sample in a sample container and a sample transporting device for transporting a sample container.

2. Description of the Related Art

Conventional sample processing systems are known for transporting sample containers through a plurality of transport units to perform sample processing.

For example, J.P. Laid-Open Patent Publication No. H11-304808 discloses a sample processing system in which a transport line is configured by a plurality of separate transport units in which each transport unit is connected to a central control part via a communication cable.

Further, J. P. Laid-Open Patent Publication No. 2000-55924 discloses a sample processing system configured by a plurality of transport lines and a rack receiving part for transporting racks, a plurality of sample processing units corresponding to the plurality of transport lines, and a central control part. In this sample processing system, the rack receiving part is provided with a reception controller, and each transport line has a line controller. In this sample processing system, the central control part and the reception controller are connected by a communication cable, and the adjacent line controllers are connected by communication cables. The central control part generates reception information indicating which sample processing unit receives a sample rack. The central processing part transmits the generated reception information to the reception controller. The reception controller transmits the reception information to the adjacent downstream line controller in conjunction with movement of the rack. The line controller that receives the reception information then determines whether the rack is received by the corresponding sample processing unit based on the reception information. When the rack is not received by the sample processing unit, the reception information is transmitted to the next line controller together with the rack. The next line controller then executes the same process.

However, in the sample processing system disclosed in J. P. Laid-Open Patent Publication No. H11-304808, each transport line unit are connected to the central control part by the communication cable, the communication cable must be increased as the distance from the central control part, and there is concern that the wiring may be complicated.

Furthermore, in the sample processing system disclosed in J. P. Laid-Open Patent Publication No. 2000-55924, the central control part cannot communicate with a specific line controller except through another controller since the information transmitted from the central control part is transmitted to the line controller on the downstream side through the receiving part and other line controller. Therefore, the information transmission process within the system is complex and accordingly, a problem that the load increases in the receiving controller and each line controller occurs.

In view of these problems, an object of the present invention is to provide a sample processing apparatus and sample transporting apparatus having simplified wiring and simplified information transmission process.

### SUMMARY OF THE INVENTION

The scope of the present invention is defined solely by the appended claims, and is not affected to any degree by the statements within this summary.

A first aspect of the present invention is a sample processing apparatus, comprising: at least one sample processing unit configured to process a sample; a plurality of transport units connected in a row to transport a sample container containing a sample to the sample processing unit via each transport unit; a transport control unit configured to control each transport unit, wherein each transport unit comprises: a repeater connected to a first cable and a second cable, and capable of receiving transport control information transmitted from the transport control unit through the first cable and relaying the received transport control information to adjacent transport unit through the second cable; and a controller capable of controlling a transport operation of the transport unit in response to the transport control information which has been received by the repeater through the first cable, and the transport control unit is connected to the first cable of a predetermined transport unit, and is capable of communicating with the controller of a particular transport unit through each repeater between the transport control unit and the particular transport unit.

A second aspect of the present invention is a sample transporting device for transporting a sample container based on transport control information received from a transport control unit, the sample transporting device comprising: a controller configured to control a transport operation of the sample transporting device in response to transport control information received from the transport control unit; and a repeater connected to a first cable and a second cable, configured to receive the transport control information from the transport control unit through the first cable, and relay the transport control information to the controller when the received transport control information specifies the sample transporting device, or relay the transport control information to the second cable when the received transport control information specifies another sample transporting device.

### BRIEF DESCRIPTION OF THE DRAWINGS

FIG. 1 is a plan view schematically showing the structure of an embodiment of the sample processing system viewed from the top;

FIG. 2(A) shows the sample container, and FIG. 2(B) shows the structure of the sample rack of the embodiment;

FIG. 3 is a plan view showing the structure of the collection unit, receiving unit, and preprocessing unit of the embodiment viewed from the top;

FIG. 4 is a plan view showing the structure of the transport unit of the embodiment viewed from the top;

FIG. 5 shows the essential structures of the collection unit, receiving unit, and preprocessing unit, and transport controller of the embodiment;

FIG. 6 shows the essential structures of the transport unit, measurement unit, and information processing unit of the embodiment;

FIG. 7 shows the essential structures of the transport unit and smear preparation device of the embodiment;

FIG. 8(A) is a flow chart of the communication process between the transport controller and the output side transport unit of the embodiment, FIG. 8(B) is a flow chart showing the communication process between the transport controller and the output side/input side units of the embodiment, and FIG. 8(C) is a flow chart showing the communication process between the transport controller and the input side unit of the embodiment; and

FIG. 9(A) is a flow chart showing the communication process between the transport controller and the information processing unit through the sample relay of the embodiment, FIG. 9(B) is a flow chart showing the communication process between the transport controller and the sample relay through the information processing unit of the embodiment, and FIG. 9(C) is a flow chart showing the communication process with the sample relay through the transport controller.

### DETAILED DESCRIPTION OF THE PREFERRED EMBODIMENTS

The present embodiment applies the present invention to a sample processing system for performing examination and analysis of blood. The sample processing system of the present embodiment is provided with three measurement units and one smear preparation device. The three measurement units perform blood analysis in parallel, and a smear sample is prepared by the smear preparation device when preparation of a smear is required based on the analysis result.

The sample processing system of the present embodiment is described below with reference to the drawings.

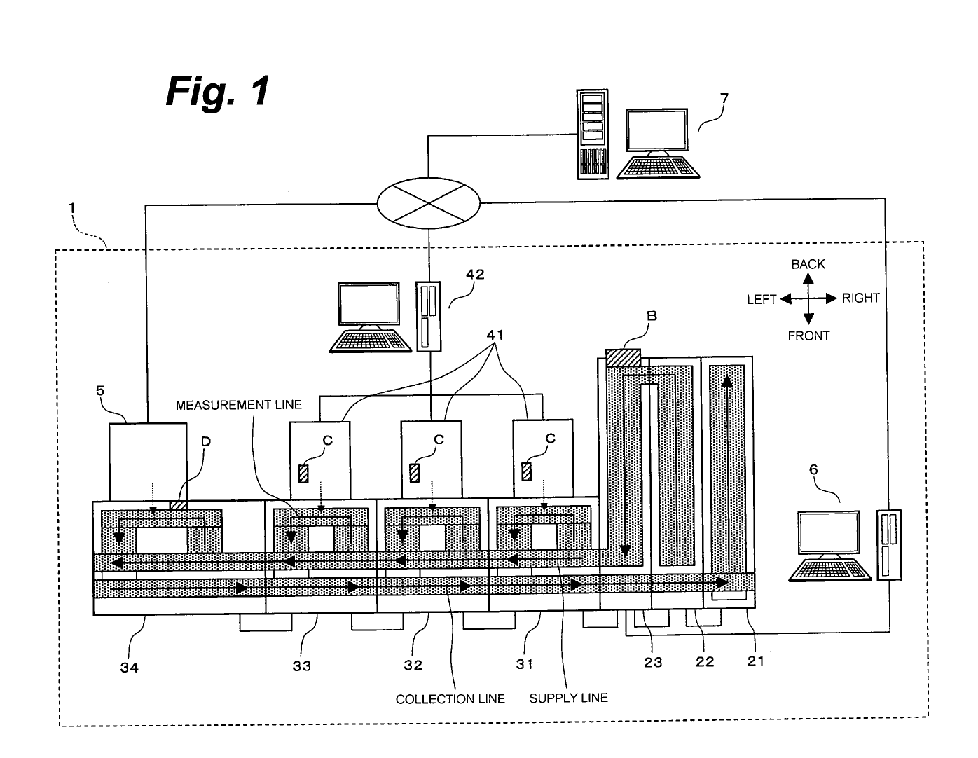

FIG. 1 is a plan view schematically showing the structure of the embodiment of the sample processing system 1 viewed from the top. The sample processing system 1 of the present embodiment is configured by a collection unit 21, a receiving unit 22, a preprocessing unit 23, transport units 31 through 34, three measurement units 41, an information processing unit 42, a smear sample preparation device 5, and a transport controller 6. The sample processing system 1 of the present embodiment also is connected to a host computer 7 through a communication network so as to be capable of communication therewith.

The collection unit 21, the receiving unit 22, and the preprocessing unit 23 are disposed adjacently left to right as shown in the drawing so as to be capable of receiving and passing on the sample rack L. These units are also configured to mount a plurality of sample racks L, which each hold ten sample containers T.

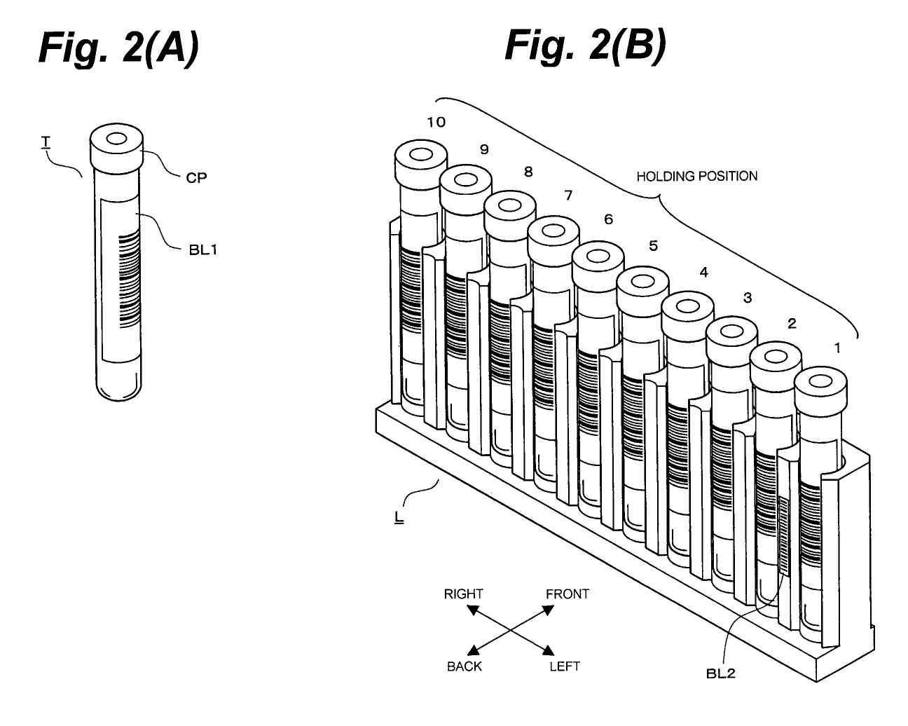

FIG. 2(A) is a perspective view showing the exterior of a sample container T, FIG. 2(B) is a perspective view showing the exterior of a sample rack L configured to hold ten sample containers T. Note that FIG. 2(B) shows the sample rack L orientation (relative to directions in FIG. 1) when loaded on a receiving unit 22.

Referring now to FIG. 2(A), the sample container T is a transparent tubular container formed of synthetic resin or glass with an open top end. A blood specimen collected from a patient is accommodated within the sample container T, and the opening at the top end is sealed by a cap CP. A barcode label BL1 is adhered to the side surface of the sample container T. A barcode representing the sample ID is printed on the barcode label BL1.

Referring to FIG. 2(B), the sample rack L has ten holders at holding positions 1 through 10 as shown in the drawing so as to be capable of holding ten sample containers T in a vertical (upright) state. A barcode label BL1 is adhered to the back side surface of the sample rack L as shown in the drawing. A barcode representing the rack ID is printed on the barcode label BL2.

Referring now to FIG. 1, the collection unit 21 accommodates the rack L which has passed through the collection line (described later).

The receiving unit 22 accommodates the sample rack L input by a user, and delivers the accommodated sample rack L to the preprocessing unit 23. To start the measurement of a sample, the user first sets the sample container T containing the sample in the sample rack L, then loads the sample rack L in the receiving unit 22. Thereafter, the sample rack L is sequentially transported to the unit on the downstream side (left side) and measurements are performed.

The preprocessing unit 23 reads the rack ID of the sample rack L delivered from the receiving unit 22, and reads the sample ID of the sample container T associated with the holding position in the sample rack L via a barcode reader B. Thereafter, the preprocessing unit 23 transmits the information read by the barcode reader B to the transport controller 6, and delivers the read sample rack L to the transport unit 31.

The transport units 31 through 34 are disposed adjacently left to right as shown in the drawing so as to be capable of receiving and passing on the sample rack L. The right end of the transport unit 31 is connected to the preprocessing unit 23 so as to be capable of accepting delivery of the sample rack L. As shown in the drawing, the transport units 31 through 34 are respectively positioned at the front of the three measurement units 41, and the transport unit 34 is positioned at the front of the smear preparation device 5, as is also shown in the drawing.

As shown in the drawing, the transport units 31 through 33 are separated into two transport lines, such that one line transports the sample rack L to the respectively corresponding measurement unit 41, and the other line does not. That is, when measurements are to be performed by the measurement unit 41, the sample rack L is transported along the so-called measurement line as indicated by the inverted U-like arrow in the back. When measurements are not to be performed by the measurement unit 41, that is, when a smear sample is to be prepared or a measurement is to be performed on the downstream side (left side), the measurement unit 41 is skipped and the sample rack L is transported along the so-called supply line as indicated by the leftward arrow in the middle. The transport units 31 through 33 are also positioned to have a rightward transport line set to transport the sample rack L to the collection unit 21, as shown in the drawing. That is, when the sample rack L does not require transport for measurement or smear preparation on the downstream side (left side), the sample rack L is transported along the so-called collection line as indicated by the rightward arrows in the front to be collected by the collection unit 21.

Note that, similar to the transport units 31 through 33, the transport unit 34 also has a measurement line, supply line, and collection line, as shown in the drawing. A barcode unit D is also provided at a predetermined position above the measurement line of the transport unit 34. The transport unit 34 reads the sample ID of the sample container T via the barcode reader D.

The three measurement units 41 remove the sample container T from the sample rack L and measure the sample contained in the sample container T at a predetermined position (dashed arrow in the drawing) on the measurement line of the transport units 31 through 33 disposed in front of the measurement units. That is, the measurement unit 41 removes the sample container T from the sample rack L and moves the sample container T backward top read the sample ID of the sample container T via a barcode reader C disposed within the measurement unit 41. Then, the measurement unit 41 measures the sample contained in the sample container T. When the measurements are completed in the within the measurement unit 41, the measurement unit 41 returns the sample container T to its original holder on the sample rack L.

The information processing unit 42 is connected to the three measurement units 41 so as to be capable of communication, and controls the operation of the three measurement units 41. The information processing unit 42 is also connected to the sample supplier (described later) of the transport units 31 through 33, and controls the operation of the sample supply part. The information processing unit 42 is also connected to a host computer 7 through a communication network so as to be capable of communication, and directs a query concerning the measurement order to the host computer 7 when the sample ID has been read by the barcode reader C within the measurement unit 41. Thereafter, the information processing unit 42 controls the measurement operation of the measurement unit 41 based on the measurement order received from the host computer 7. The information processing unit 42 also performs analysis based on the measurement results of the measurement unit 41.

The smear sample preparation device 5 is connected to the host computer 7 through a communication network so as to be capable of communication, and directs a query concerning the measurement order to the host computer 7 when a sample ID read by the barcode reader D has been received from the transport unit 34. Thereafter, the smear sample preparation device 5 aspirates the sample contained in the sample container T at a predetermined position (dashed arrow in the drawing) on the measurement line of the transport unit 34, and prepares a smear of the sample based on the measurement order received from the host computer 7.

Note that whether or not to prepare a smear sample is determined by the transport controller 6 based on the analysis result obtained by the information processing unit 42. When the transport controller determines that preparation of a smear sample is required, the sample rack L that accommodates the target sample is transported along the measurement line of the measurement unit 34, and a smear sample is prepared in the smear sample preparation device 5.

The transport controller 6 controls the transport operations of the collection unit 21, receiving unit 22, preprocessing unit 23, and transport units 31 through 34. The transport controller 6 is also connected to the host computer 7 through a communication network so as to be capable of communication. The transport controller 6 directs a query concerning the measurement order to the host computer 7 when a sample ID has been received from the preprocessing unit 23. Thereafter, the transport controller 6 determines the destination of the sample rack L output from the preprocessing unit 23 based on the measurement order received from the host computer 7, and controls the transport units 31 through 34 so as to deliver the sample rack L to the destination.

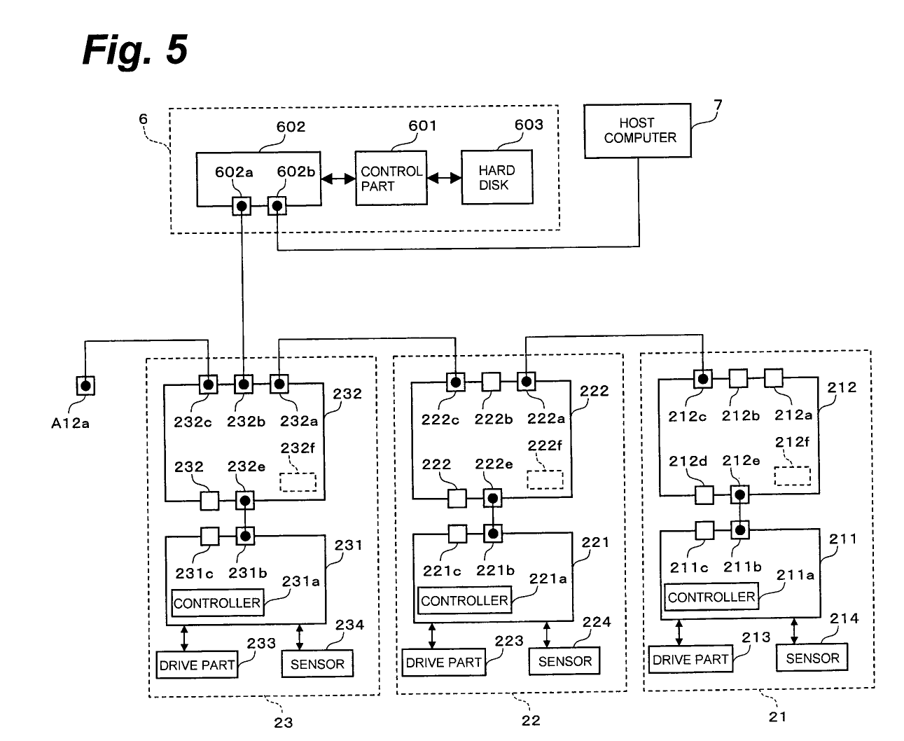

The collection unit 21, receiving unit 22, preprocessing unit 23, and transport units 31 through 34 (hereinafter referred to as transport unit group) are respectively connected to the respectively adjacent unit so as to be capable of communication. The preprocessing unit 23 is also connected to the transport controller so as to be capable of communication. The transport unit group is provided with a communication parts so that the transport controller 6 can directly issue control instructions to each unit of the transport unit group. Note that the communication parts respectively provided to the transport unit group are described later with reference to FIGS. 5 through 7.

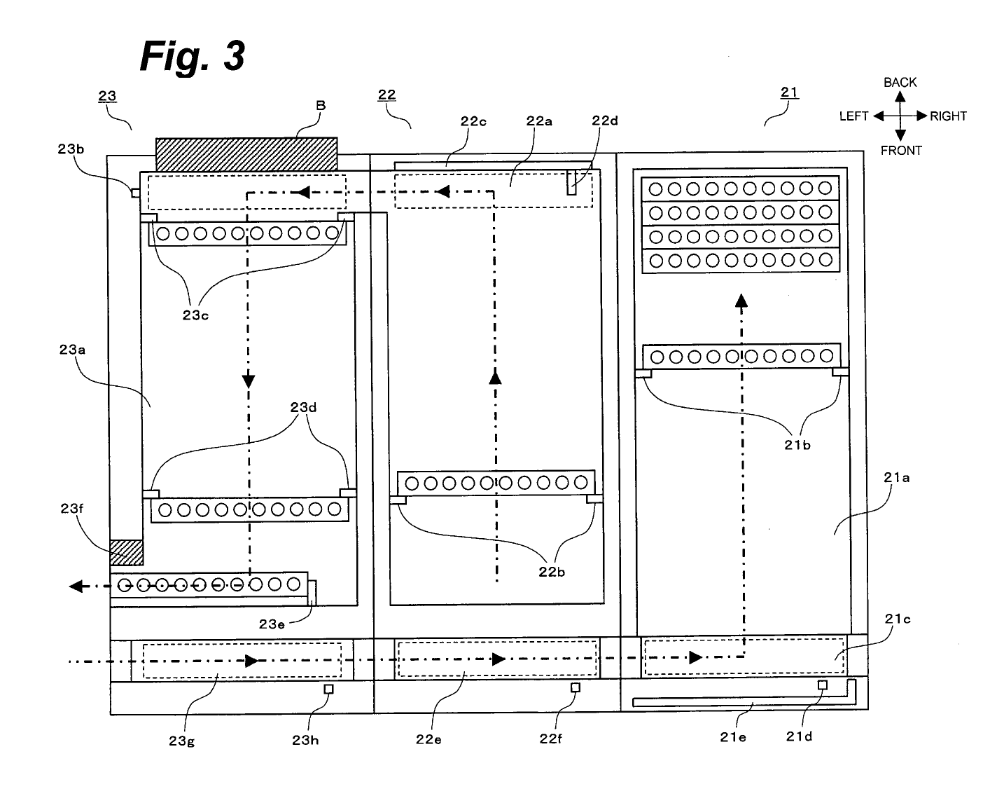

FIG. 3 is a plan view showing the structures of the collection unit 21, receiving unit 22, and preprocessing unit 23 viewed from above.

When a sample rack L holding a sample container T is loaded on a transport path 22a of the receiving unit 22, the rack transport mechanism 22b moves backward while connected to the front end of the sample rack L, such that the sample rack L is moved to the back position of the transport path 22a. A contact sensor 22c for detecting contact with the sample rack L is provided near the back position of the transport path 22a. The sensor 22c detects the sample rack L when the sample rack L arrives at the back position of the transport path 22a via the rack transport mechanism 22b. Thereafter, the sample rack L is output to the back position of a transport path 23a of the preprocessing unit 23 when the rack delivery mechanism 22d presses the right side surface of the sample rack L.

A reflective sensor 23b is provided near the back position of the transport path 23a of the preprocessing unit 23, as shown in the drawing. When the sensor 23b detects the sample rack L delivered by the receiving unit 22 at the back position of the transport path 23a, the barcode reader B reads the rack ID and the sample ID corresponding to the holding position of the sample rack L.

Then, the sample rack L that has been read by the barcode reader B is moved forward from the back position of the transport path 23a a distance comparable to the width of the sample rack L in the front-to-back direction. Thereafter, the rack transport mechanism 23d moves the sample rack L forward while connected to the back side surface of the sample rack L, such that the sample rack L is moved to the forward position of the transport path 23a. The sample rack L disposed at the forward position of the transport path 23a is then moved leftward when the rack transport mechanism 23e pushes the right side surface of the sample rack L.

In this case, the sample rack L is moved somewhat to the left side from the front position of the transport path 23a, and the rack ID on the barcode label BL1 of the sample rack L is read by the barcode reader 23f when the sample rack L is positioned in front of the barcode reader 23f. When the barcode reader 23f has read the rack ID, the preprocessing unit 23 transmits the rack ID to the transport controller 6. The transport controller 6 determines the destination of the sample rack L as either the measurement unit 41 or the smear preparation device 5 based on the received rack ID. Thereafter, the sample rack L is pushed to the left by the rack transport mechanism 23e, so as to be delivered to the transport unit 31.

When the sample rack L has been transported from the measurement unit 41 or the smear preparation device 5 along the collection line to the preprocessing unit 23, the sample rack L is disposed at the front position (position at the right end of the belt 21c) of the collection unit 21 by the belt 21c of the collection unit 21 and the belt 22e of the receiving unit 22. Note that reflective sensors 23h, 22f, and 21d are respectively disposed near the belts 23g, 22e, and 21c. The sensors 23h, 22f, and 21d detect the sample rack L positioned on the belts 23g, 22e, and 21c.

When the sample rack L is disposed at the front position of the collection unit 21, the rack pushing mechanism 21e pushes the sample rack L from the position in front of the collection unit 21 onto the transport path 21a. Thereafter, the rack transport mechanism 21b moves the sample rack L forward while connected to the front side surface of the sample rack L, such that the sample rack L is moved to the back position of the transport path 21a. Thus, the sample racks L holding the previously measured sample containers T are sequentially collected in a back direction on the transport path 21a of the collection unit 21.

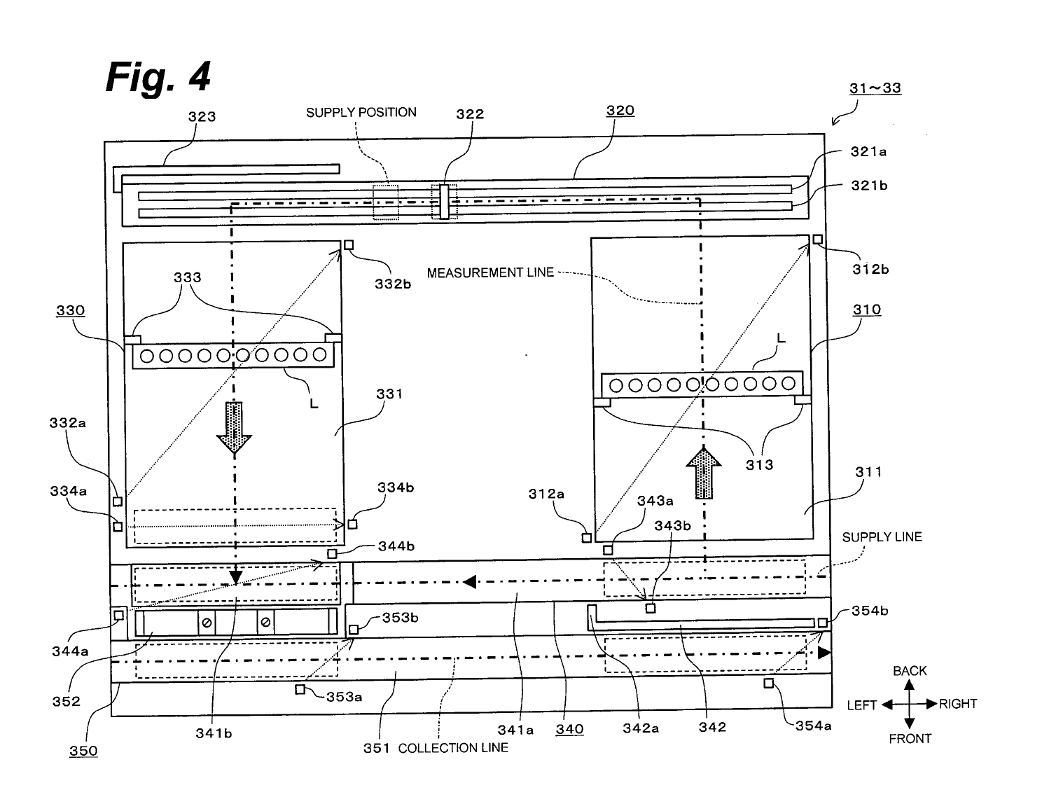

FIG. 4 is a plan view showing the structure of the transport units 31 through 33 viewed from the top. The transport units 31 through 33 have a right table 310, a rack transporter 320, a left table 330, and rack transporters 340 and 350. The right table 310, rack transporter 320, and left table 330 configure the measurement line shown in FIG. 1. The rack transporter 340 configures the supply line shown in FIG. 1, and the rack transporter 350 configures the collection line shown in FIG. 1. Note that the transport units 31 through 33 are identical in structure.

When measurement of the sample rack L output from the upstream side (right side) cannot be performed by the measurement unit 41 of the corresponding transport unit, the sample rack L is directly transported along the supply line from the right end to the left end of the rack transporter 340 via the belts 341a and 341b of the rack transporter 340. Transmission type sensors 344a and 344b are provided near the left end of the rack transporter 340. The sensors 344a and 344b detect the sample rack L at the left end position of the track transporter 340. Thereafter, the sample rack L is moved to the transport unit on the downstream side (left side) via the belt 341b of the rack transporter 340.

When measurement of the sample rack L output from the upstream side (right side) can be performed by the measurement unit 41 of the corresponding transport unit, the sample rack L is disposed at the right end position of the rack transporter 340. That is, the rack pushing mechanism 342 is moved backward while the belt 341a is being driven so that the wall 342a protrudes somewhat on the supply line from the state shown in the drawing. Thus, the sample rack L that has been transported from the upstream side is stopped by abutting the wall 342a. Transmission type sensors 343a and 343b are provided near the right end position of the rack transporter 340.

The sensors 343a and 343b detect the sample rack L at the right end position of the track transporter 340.

The sample rack L is then pushed to the front position of the transport path 311 of the right table 310 by moving the rack pushing mechanism 342 backward. When the transmission type sensors 312a and 312b detect the sample rack L on the transport path 311, the rack transport mechanism 313 moves backward while connected to the front end of the sample rack L, thus moving the sample rack L backward. When the sample rack L reaches the right end position of the rack transporter 320, the sample rack L is moved leftward by the driven belts 312a and 312b. Note that since the belts 312a and 312b are driven by a stepping motor (not shown in the drawing), the sample rack L on the rack transporter 320 can be moved accurately according to the number of steps of the stepping motor.

Thereafter, the sample rack L is moved to the position of the contact type container sensor 322. When the sample container T held in the sample rack L passes the position directly under the container sensor 322, the contact part of the container sensor 322 is bent by the sample container T, thus detecting the presence of the sample container T.

At the supply position a distance of two widths of the sample container T on the left side from the detection position of the sample container T, a hand part (not shown in the drawing) of the measurement unit 41 grips the sample container T and removed the sample container T from the sample rack L. The removed sample container T is returned to the same sample rack L after having been measured in the measurement unit 41. The transport of the sample rack L is on standby until the sample container T is returned to the sample rack L.

Thus, when processing, such as sample measurements, has been completed for all sample containers T requiring measurement by the measurement unit 41 among the containers T held in the sample rack L, the sample rack L is moved to the left end position of the rack transporter 320 by the belts 321a and 321b. Thereafter, the sample rack L is pushed to the back position of the transport path 331 of the left table 330 by the rack pushing mechanism 323. When the sample rack L is detected on the transport path 331 by the transmission type sensors 332a and 332b, the rack transport mechanism 333 moves forward while connected to the back end of the sample rack L. Thus, the sample rack L is moved forward.

Transmission type sensors 334a and 334b are provided near the front position of the left table 330. The sample rack L is detected at the front position of the left table 330 by the sensors 334a and 334b.

A partition 352 is controllably operated between the rack transporters 340 and 350 at the front of the left table 330, such that the sample rack L is disposed either at the left end position of the rack transporter 340 or the left end position of the rack transporter 350.

For any sample container T held in the sample rack L, the rack transporters 340 and 350 are partitioned by the partition 352 when the processing, such as measurements, is required by the measurement units 41 or the smear preparation device 5 on the downstream side, and the sample rack 1 is moved to the left end position of the rack transporter 340 by the rack transport mechanism 333. Thereafter, the sample rack L is moved to the transport unit on the downstream side (left side) via the belt 341b of the rack transporter 340.

Alternatively, for sample containers T held in the sample rack L, the top surface of the partition 352 is lowered to the same height of the top surface of the belt 341b of the rack transporter 340 when processing, such as measurements, is required by either the measurement units 41 or the smear preparation device 5 on the downstream side, and the sample rack 1 is moved to the left end position of the rack transporter 350 by the rack transport mechanism 333. Thus, the sample rack L is moved from the left table 330 to the left end position of the rack transporter 350 across the rack transporter 340 by the rack transporter 333. When the sample rack L is disposed at the left end position of the rack transporter 350, the sample rack L is detected by the transmission type sensors 353a and 353b provided near the left end position of the rack transporter 350.

The sample rack L is then moved from the left end to the right end of the rack transporter 350 along the collection line by the belt 351 of the rack transporter 350. Transmission type sensors 354a and 354b are provided near the right end of the rack transporter 350. The sensors 354a and 354b detect the sample rack L at the right end position of the track transporter 350. Thereafter, the sample rack L is moved to the unit disposed on the right side of the transport unit, and ultimately collected by the collection unit 21.

FIG. 5 briefly shows the structures of the collection unit 21, receiving unit 22, preprocessing unit 23, and transport controller 6.

The collection unit 21 has a control board 211, communication part 212, drive part 213, and sensor part 214.

The control board 211 has a controller 211a, and communication terminals 211b and 211c. The controller 211a controls the drive part 213 and the sensor part 214. The communication terminals 211b and 211c are communication interfaces based on the Ethernet (registered trademark) standard. The communication terminals 211b and 211c have specific information (hereinafter referred to as communication terminal information) for identifying the communication terminals 211b and 211c, respectively. The controller 211a performs data communication with other devices via the communication terminals 211b and 211c. The communication terminal 211b is connected via cable to a port 212e of the communication part 212.

The communication part 212 is provided with ports 212a through 212e, and a table 212f. The ports 212a through 212e are respectively communication interfaces based on the Ethernet (registered trademark) standard. The table 212f has pre-stored information relating to the communication terminals of the cables connected to ports 212a through 212e. That is, the table 212f has pre-stores communication terminal information of the communication terminals corresponding to the ports 212a through 212e.

The data received between communication terminals contain transmission source information and transmission destination information, and the communication terminal information is written in the transmission source information and the transmission destination information. When the data are received at the ports 212a through 212e, the communication part 212 associates the port at which the data are received and the communication terminal information written in the transmission origin information contained in the data, and stores this associated information in the table 212f. Thus, the table 212f is constructed according to the layout of the sample processing unit 1. Similarly, the table 212f is dynamically constructed according to the modified layout even when the layout of the sample processing unit 1 has been modified.

When the communication part 212 receives the data at ports 212a through 212e, the communication part 212 references the communication terminal information written in the transmission destination information that is contained in the data. The communication part 212 also sequentially references the constructed table 212f and determines whether the communication terminal information previously exists for a cable connected to a port, sequentially. The communication port 212 then relays (transmits) the received data to the port determined by referencing the table 212f.

Note that a switching hub, for example, may be used as the communication part 212. In this case, MAC addresses are used as the communication terminal information, and the MAC addresses are associated with the ports 121a through 212e and stored in the table 212f.

The drive part 213 incorporates the rack transport mechanism 21b, belt 21c, and a mechanism for driving the rack pushing mechanism 21e of FIG. 3. The sensor part 214 includes the sensor 21d of FIG. 3, and the sensor part 214 outputs a detection signal to the control board 211.

The receiving unit 22 has the same structure as the collection unit 21, as shown in the drawing. That is, the receiving unit 22 has a control board 221, communication part 222, drive part 223, and sensor part 224. The control board 221 has a controller 221a and communication terminals 221b and 221c; the communication part 222 has ports 222a through 222e and a table 222f. The sensor part 224 includes the sensors 22c and 22f of FIG. 3.

The preprocessing unit 23 has the same structure as the collection unit 21, as shown in the drawing. That is, the preprocessing unit 23 has a control board 231, communication part 232, drive part 233, and sensor part 234. The control board 231 has a controller 231a and communication terminals 231b and 231c; the communication part 232 has ports 232a through 232e and a table 232f. The sensor 234 includes the barcode reader B, barcode reader 23f, and sensors 23b and 23h of FIG. 3.

The transport controller 6 is provided with a control part 601, a communication part 602, and a hard disk 603.

The control part 601 communicates with the preprocessing unit 23 and the host computer 7 through the communication part 602. The control part 601 controls the transport unit group based on the position information of the sample rack L stored in the hard disk 603, and the destination of the sample rack L. The communication part 602 has communication terminals 602a and 602b. The communication terminals 602a and 602b are communication interfaces for performing data communication with other devices based on the Ethernet (registered trademark) standard. The communication terminal 602a is connected to the port 232b of the preprocessing unit 23, and the communication terminal 602a is connected to the host computer 7.

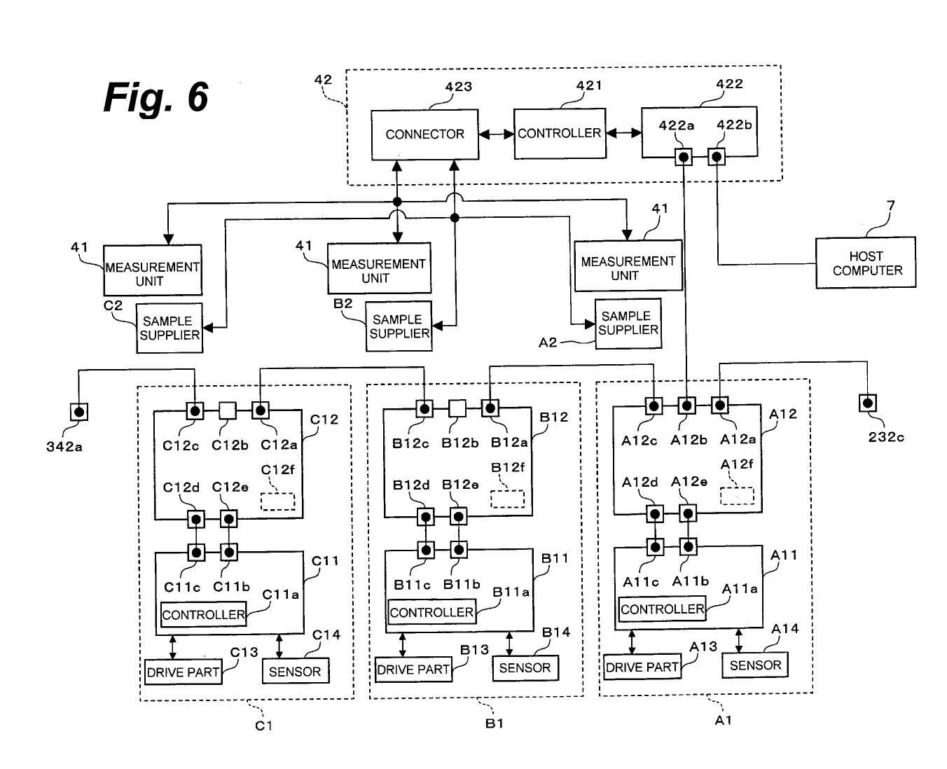

The port 212c of the collection unit 21 is connected to the port 222a of the receiving unit 22, the port 222c of the receiving unit 22 is connected to the port 232a of the preprocessing unit 23, and the port 232c of the preprocessing unit 23 is connected to the port A12a (refer to FIG. 6) of the sample relay A1 incorporated in the transport unit 31.

Thus, the control part 601 of the transport controller 6 can directly communicate with the controller 211a of the collection unit 21, and the controller 221a of the receiving unit 22, the controller 231a of the preprocessing unit 23. That is, the control part 601 communicates directly with the controller 211a of the collection unit 21 through the communication parts 232, 222, and 212, and not through the control board 231 of the preprocessing unit 23 and the control board 221 of the receiving unit 22. The control part 601 communicates directly with the controller 221a of the receiving unit 22 through the communication parts 232 and 222, and not through the control board 231 of the preprocessing unit 23. The control part 601 communicates directly with the controller 231a of the preprocessing unit 23 through the communication part 232.

FIG. 6 briefly shows the structures of the transport units 31 through 33, the measurement units 41, and the information processing unit 42.

The transport unit 31 is divided into a sample relay A1 and a sample supplier A2, the transport unit 32 is divided into a sample relay B1 and a sample supplier B2, and the transport unit 33 is divided into a sample relay C1 and a sample supplier C2. The sample relays A1, B1, and C1 are parts that include the left table 330 and the rack transporters 340 and 350 of FIG. 4; they receive the sample rack L from one of the adjacent two units, and move the rack L to the other unit. The sample suppliers A2, B2, and C2 are parts that include the right table 310 and the rack transporter 320; they move the sample rack L to the supply position so that the sample can be measured by the measurement unit 41. Note that since the sample relays A1, B1, and C1 have identical structures and the sample suppliers A2, B2, and C2 have identical structures, only the structures of the sample relay A1 and the sample supplier A2 of the transport unit 31 are described below among the transport units 31 through 33.

The sample relay A1 has the same structure as the collection unit 21 of FIG. 5 as shown in the drawing. That is, the sample relay A1 is provided with a control board A11, communication part A12, drive part A13, and sensor part A14. The control board A11 has a controller A11a and a communication terminals A11b and A11c, and the communication part A12 is provided with ports A12a through A12e and a table A12f.

The drive part A13 includes the rack transport mechanism 333, belts 341a, 341b, and 351, partition 352, and a mechanism for driving the rack pushing mechanism 342 of FIG. 4. The sensor part A14 includes sensors 332a and 332b, sensors 334a and 334b, sensors 343a and 343b, sensors 344a and 344b, sensors 353a and 353b, and sensors 354a and 354b. The communication terminal A11b and the port A12e are connected by a cable, and the communication terminal A11c and the port A12d are connected by a cable.

The sample supplier A2 is provided with a drive part and a sensor part that are not shown in the drawing. The drive part incorporates the rack transport mechanism 313, belts 321a and 321b, and a mechanism for driving the rack pushing mechanism 323 of FIG. 3. The sensor part includes the sensors 312a and 312b, and the container sensor 322 of FIG. 4.

The measurement unit 41 is provided with a drive part and a sensor part that are not shown in the drawing. The drive part moves the sample container T within the measurement unit 41, and includes a device for measuring the sample contained in the sample container T. The sensor part includes a sensor for detecting the sample container T within the measurement unit 41 as well as the barcode reader C shown in FIG. 1.

The information processing unit 42 is provided with a controller 421, a drive part 422, and a connector 423.

The controller 421 communicates with the sample relay A1 and the host computer 7 through the communication part 422. The connector 421 communicates with the sample suppliers A2, B2, and C2, and the three measurement units 41 through the connector 423, so as to control these devices and receive the signals output from the sensors of these devices. The communication part 422 has communication terminals 422a and 422b. The communication terminals 422a and 422b are communication interfaces for performing data communication with other devices based on the Ethernet (registered trademark) standard. The communication terminal 422a is connected to the port A12b of the sample relay A1, and the communication terminal 422b is connected to the host computer 7. The connector 423 is connected to the sample suppliers A2, B2, and C2 and the three measurement units 41 based on the USB (universal serial bus) standard.

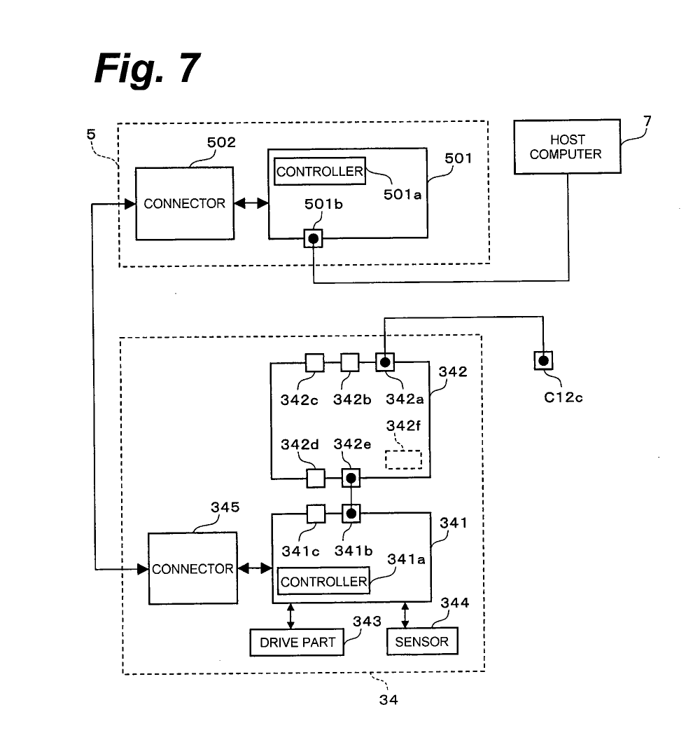

The port A12a of the sample relay A1 is connected to the port 232c of the preprocessing unit 23, the port A12c of the sample relay A1 is connected to the port B12a of the sample relay B1, the port B12c of the sample relay B1 is connected to the port C12a of the sample relay C1, and the port C12c of the sample relay C1 is connected to the port 342a of the transport unit 34 (refer to FIG. 7).

Thus, the control part 601 of the transport controller 6 can directly communicate with the controllers of the sample relays A1, B1, and C1. That is, the control part 601 directly communicates with the control part A11a of the sample relay A1 through the communication parts 232 (refer to FIGS. 5) and A12 and not through the control board 231 (refer to FIG. 5) of the preprocessing unit 23. The control part 601 directly communicates with the controller B11a of the sample relay B1 through the communication parts 232, A12, and B12 and not through the control board A11 of the sample relay A1 and the control board 231 of the preprocessing unit 23. The control part 601 also directly communicates with the controller C11a of the sample relay C1 through the communication parts 232, A12, B12, and C12 and not through the control board B11 of the sample relay B1, the controller A11 of the sample relay A1, and the control board 231 of the preprocessing unit 23.

The controller 421 of the information processing unit 42 can directly communicate with the controllers of the sample relays A1, B1, and C1. That is, the controller 421 can directly communicate with the controller A11a of the sample relay A1 through the communication part A12. The controller 421 directly communicates with the controller B11a of the sample relay B1 through the communication parts A12 and B12 and not through the control board A11 of the sample relay A1. The controller 421 also communicates with the controller C11a of the sample relay C1 through the communication parts 232, A12, B12, and C12 and not through the control board B11 of the sample relay B1, and the controller A11 of the sample relay A1.

Note that communication terminals of the sample relays A1, B1, and C1 used for communication via the information processing unit 42 and the communication terminals of the transport unit group used for communication via the transport controller 6 are set so as to belong to different networks. For example, the network addresses of the communication terminals 422a, A11c, B11c, and C11c are set so as to be different than the network addresses of the communication terminals 602a, 211b, 221b, and 231c of FIG. 5, communication terminals A11b, B11b, and C11b of FIG. 6, and communication terminal 341b of FIG. 7.

FIG. 7 briefly shows the structures of the transport unit 34 and the smear preparation device 5.

The transport unit 34 is configured as the collection unit 21 with the addition of the connector 345 as shown in the drawing. That is, the transport unit 34 has a control board 341, communication part 342, drive part 343, and sensor part 344. The control board 341 is provided with communication terminals 341b and 341c, and the communication part 342 is provided with ports 342a through 242e and a table 342f.

The drive part 343 includes a mechanism to move the sample rack L on the transport unit 34. The sensor part 344 includes a sensor to detect the sample rack L on the transport unit 34 in addition to the barcode reader D of FIG. 1. The communication terminal 341b and the port 342e are connected by a cable.

The connector 345 is connected to the connector 502 of the smear preparation device 5 based on the RS-232C standard. The controller 341a transmits aspiration instructions and the sample ID read by the barcode reader D to the smear preparation device 5 through the connector 345.

In this case the port 342a of the transport unit 34 and the port C12c of the sample relay C1 are connected. Thus, the control part 601 of the transport controller 6 directly communicates with the controller 341a of the transport unit 34. That is, the control part 601 directly communicates with the controller 341a of the transport unit 34 through the communication parts 232 (refer to FIGS. 5), A12, B12, and C12 (refer to FIG. 6) and not through the control board 231 (refer to FIG. 5), A12, B12, C12 (refer to FIG. 6) of the preprocessing unit 23.

The smear preparation device 5 is provided with a control board 501 and a connector 502. The control board 501 has a connector 501a and a communication terminal 501b. The communication terminal 501b is a communication interface for performing data communication with other devices based on the Ethernet (registered trademark) standard. The communication terminal 501b is connected to the host computer 7. The connector 502 is connected to the connector 345 of the transport unit 34 based on the RS-232C standard.

The controller 501a directs a query concerning the measurement order to the host computer 7 when a sample ID is received from the transport unit 34 through the connector 502. When the connector 501a receives and aspiration instruction from the transport unit 34 through the connector 502, the sample is aspirated from the sample container T disposed at the supply position on the measurement line of the transport unit 34, and a smear sample is prepared based on the measurement order.

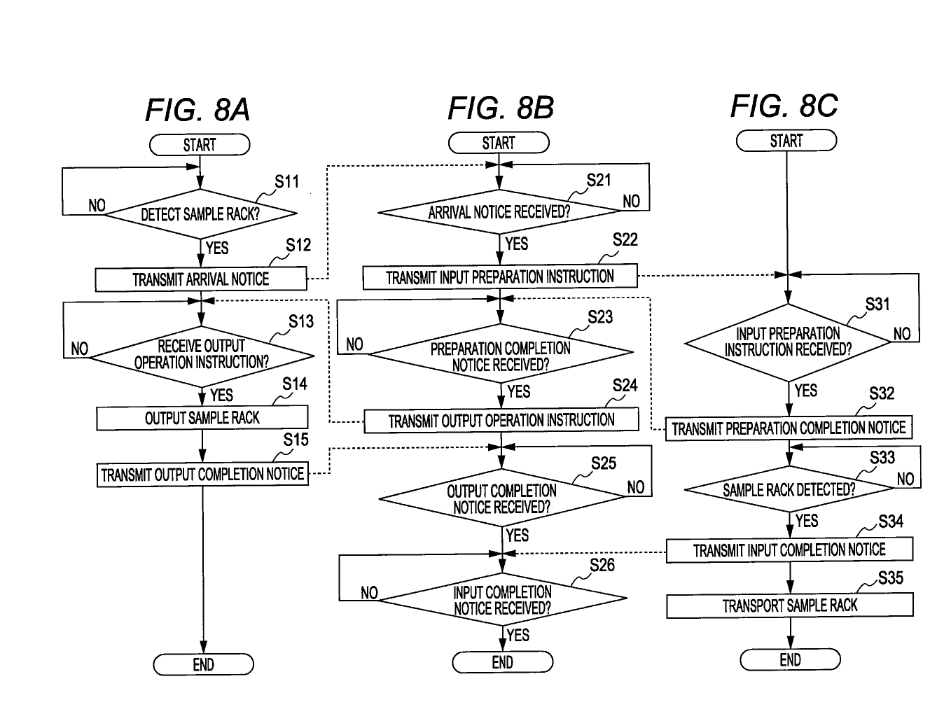

FIGS. 8(A), 8(B), and 8(C) are flow charts respectively showing the communication process with the transport controller 6 via the output side unit, the communication process with output side/input side units and the transport controller 6, and the communication process with the transport controller 6 via the input side unit.

Note that “output side unit” and “input side unit” represents the upstream unit and the downstream unit when the sample rack L is transported between adjacent units in a lateral direction. Specifically, the receiving unit 22, preprocessing unit 23, sample relays A1, B1, and C1, and the transport unit 34 become the output side unit. The collecting unit 21, receiving unit 22, preprocessing unit 23, sample relays A1, B1, and C1, and the transport unit 34 become the input side unit.

Referring now to FIG. 8(A), when the sensor detects the sample rack L at the output position (S11: YES), the controller of the output side unit transmits an arrival notice directly to the controller 6 without passing through the control board of another unit as described above (S12).

In this case, the “output position” is the position farthest downstream from the output side unit. That is, when the sample rack L is output to the left, the back position of the transport path 22a of the receiving unit 22, the front surface position of the barcode reader 23f of the preprocessing unit 23, and the left end position of the rack transporter 340 of the transport units 31 through 33 all become the output position. When the sample rack L is output to the right along the collection line, the position on the belt 22e of the receiving unit 22, the position on the belt 23g of the preprocessing unit, and the position at the right end of the rack transporter 350 of the transport units 31 through 34 all become the output position.

Referring now to FIG. 8(B), when an arrival notice is received from the output side unit (S21: YES), the control part 601 of the transport controller 6 transmits input preparation instruction directly to the input side unit without passing through the control board of the other units (S22) as described above. The input preparation instruction contains the operational content to be performed by the input side unit based on the destination of the sample rack L.

Referring now to FIG. 8(C), when the input preparation instruction is received from the transport controller 6 (S31: YES), the controller of the input side unit prepares to receive the sample rack L from the output side unit based on the input preparation instruction. When the input side unit completes preparations for receiving the sample rack L, the input side unit transmits a preparation completion notice directly to the transport controller 6 without passing through the control boards of the other units as described above.

Referring now to FIG. 8(B), when the preparation completion notice is received from the input side unit (S23: YES), the control part 601 of the transport controller 6 transmits an output operation instruction directly to the output side unit without passing through the other control boards (S24).

Referring to FIG. 8(A), when the output operation instruction is received from the transport controller 6 (S13: YES), the controller of the output side unit outputs the sample rack L disposed at the output position to the input side unit (S14). When the output of the sample rack L is completed, the controller of the output side unit transmits an output completion notice directly to the transport controller 6 (S15) without passing through the other control boards, and the process of FIG. 8(A) ends. Note that when the process of FIG. 8(A) ends, the output side unit becomes the next input side unit and the process of FIG. 8(C) is performed.

Referring to FIG. 8(C), when the sensor detects the sample rack L output from the output side unit has arrived at the input position (S33: YES), the controller of the input side unit transmits an input completion notice directly to the transport controller 6 without passing through the control boards of the other units.

In this case, the “input position” is the position farthest upstream from the input side unit. That is, when the sample rack L is moved to the left, the back position of the transport path 23a of the preprocessing unit 23, and the right end position of the rack transporter 340 of the transport units 31 through 34 become the input position. When the sample rack L is moved to the right along the collection line, the position on the belt 21c of the collection unit 21, the position on the belt 22e of the receiving unit 22, the position on the belt 23g of the preprocessing unit 23, and the position at the left end of the rack transporter 350 of the transport units 31 through 33 become the input position.

The controller of the input side unit moves the received sample rack L within the input side unit (S35), and the process of FIG. 8(C) ends. Note that when the process of FIG. 8(C) ends, the input side unit becomes the next output side unit and the process of FIG. 8(A) is performed.

Referring to FIG. 8(B), when the output completion notice is received from the output side unit (S25: YES), the control part 601 of the transport controller 6 updates the position information of the sample rack L stored on the hard disk 603 based on this reception. When the input completion notice is received from the input side unit (S26: YES), the control part 601 similarly updates the position information of the sample rack L. Then, the process of FIG. 8(B) ends.

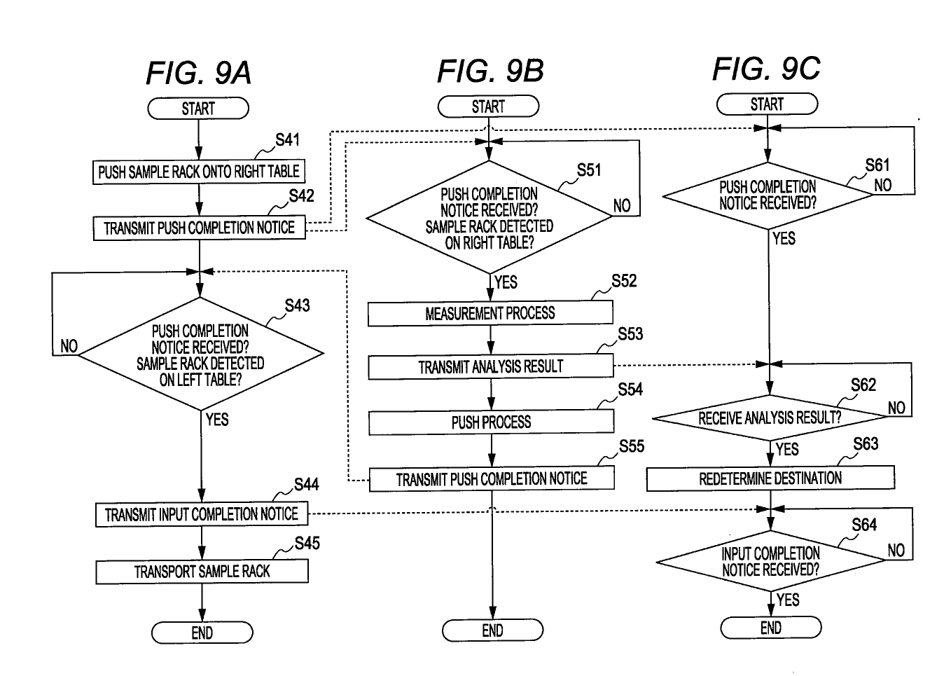

FIGS. 9(A), 9(B), and 9(C) are flow charts respectively showing the communication process between the information processing unit 42 and the transport controller 6 via the sample relay, the communication process between the sample relay and the transport controller 6 via the information processing unit 42, and the communication process between the sample relay and the information processing unit 42 via the transport controller 6.

Note that since the process of FIG. 9(A) is identical in each sample relay A1, B1, C1, the process of FIG. 9(A) is described below as the process performed by sample relay B1. The processes of FIGS. 9(B) and 9(C) are executed when the measurement unit 41 positioned behind the sample relay is the destination. That is, according to FIG. 8(C), the process of FIG. 9(A) is started when the sample rack L is input to the rack transporter 340, and the sample rack L abuts the partition 342a of the rack pushing mechanism 342 so as to be disposed at the right end position of the rack transporter 340.

Referring to FIG. 9(A), the controller B11a of the sample relay B1 pushes the sample rack L that is disposed at the right end position of the rack transport 340 to the right table 310 via the rack pushing mechanism 342. When the sample rack L is pushed on the right table 310, the controller B11a transmits a push completion notice directly to the transport controller 6 and the information processing unit 42 (S42). That is, the controller B11a transmits the push completion notice from the communication terminal B11c to the communication terminal 422a of the information processing unit through the communication parts B12 and A12. The controller B11a also transmits an output completion notice from the communication terminal B11b to the communication terminal 602a of the transport controller 6 through the communication parts B12, A12, and 232.

Referring to FIG. 9(B), when the controller 421 of the information processing unit 42 receives the push completion notice from the sample relay A1 and the sensors 312a and 312b of the sample supplier A2 detect the sample rack L (S51: YES), the measurement process is performed (S52). That is, the controller 421 drives each part of the sample supplier A2, and moves the sample rack L disposed at the right table 310 to the supply position of the rack transporter 320. Thereafter, the controller 421 drives the measurement unit 41 corresponding to the sample supplier A2, and measures the sample targeted for measurement.

When the sample measurement are completed for all measurement targets on the sample rack L, the controller 421 analyzes the measurement results of the samples, and transmits the analysis results from the communication terminal 422 to the communication terminal A11c of the control board A11 through the ports A12b and A12d of the communication parts Al2.1 The controller A11a of the sample relay A1 transmits the analysis results received at the communication terminal A11c from the communication terminal A11b to the transport controller 6 through the ports A12e and A12a of the communication part A12. Thus, the analysis results are transmitted from the information processing unit 42 to the transport controller 6 (S53).

Then, the controller 421 drives the parts of the sample supplier B2 to move the sample rack L to the left end position of the rack transporter 320, and the sample rack L is pushed onto the left table 330 by the rack pushing mechanism 323 of the sample supplier B2 (S54). When the sample rack L is pushed on the left table 330, the controller 421 transmits a push completion notice directly to the sample relay B1 without passing through the control board of another unit (S55). That is, the controller 421 transmits the push completion notice from the communication terminal 422a to the communication terminal B11b of the sample relay B1 through the communication parts A12 and B12. Then, the process of FIG. 9(B) ends.

Referring to FIG. 9(A), when the push completion notice is received from the information processing unit 42 and the sensors 332a and 332b of the sample relay B1 detect the sample rack L on the left table 330 (S43: YES), the controller B11a of the sample relay B1 transmits an input completion notice directly to the transport controller 6 without passing through the control board of another unit (S44). Then, the controller B11a moves the sample rack L to the front position of the left table 330 via the rack transport mechanism 333. Then, the process of FIG. 9(A) ends. Note that when the sample rack L is disposed at the front position of the left table 333, the sample relay B1 becomes the output unit and the process of FIG. 8(A) ends.

Referring to FIG. 9(C), when the push completion notice is received from the sample relay A1 (S61: YES), the control part 601 of the transport controller 6 updates the position information of the sample rack L stored on the hard disk 603 of the transport controller 6 based on the received notice. When the analysis results are received from the information processing unit (S62: YES), the control part 601 again determines the destination of the sample rack L disposed at the position of the rack transporter 320 based on the received analysis result (S63).

When the input completion notice is received from the sample relay B1 (S64: YES), the control part 601 updates the position information of the sample rack L stored on the hard disk 603 based on the received notice. Then, the process of FIG. 9(C) ends.

Note that when the sample rack L is disposed at the front position of the left table 330 of the transport units 31 through 33, an arrival notice is transmitted to the transport controller 6 (S12) as shown in FIG. 8(A). The transport controller 6 controls the sample relay that transmitted the arrival notice based on the newly determined destination of the sample rack L.

That is, when the newly determined destination of the sample rack L is the smear preparation device 5 or a measurement unit 41, the transport controller 6 transmits an input preparation instruction to the sample relay on the downstream side (left side), that is, the input side (S22), as shown in FIG. 8(B). Thus, the sample rack L is output from the front position of the left table 330 to the downstream side (left side) sample relay through the left end position of the rack transporter 340. When the newly determined destination of the sample rack L is the collection unit 21, the transport controller 6 moves the sample rack L disposed at the front position of the left table 330 to the right end position of the rack transporter 350 of the sample relay that transmitted the arrival notice. When the sample rack L is disposed at the right end position of the rack transporter 350, the sample relay becomes the output side unit, and the process of FIG. 8(A) starts again.

According to the present embodiment, the transport unit group is provided with communications parts for each unit, so as to be capable of communication via connection to the communication part of the laterally adjacent units. Thus, the wiring can be simplified since the connections between controllers of the transport units can be made using shorter cables compared to when the transport controller 6 is connected via cables to each unit of the transport unit group.

According to the present embodiment, the transport controller 6 and the information processing unit 42 can communicate directly with the controllers of each unit of the transport unit group without passing through another controller. Thus, the load on each controller of the transport unit group is reduced since the controllers o the transport unit group do not receive communication data relating to the control of another unit in the transport unit group.

According to the present embodiment, the communication terminals of the sample relays A1, B1, and C1 used for communication via the information processing unit 42 and the communication terminals of the transport unit group used for communication via the transport controller 6 are set so as to belong to different networks. Thus, since the communications performed by the information processing unit 42 using the sample relays A1, B1, and C1 are separate from the communications performed by the transport controller 6 using the transport group, the increase in communication time and generation of communication errors that impact communications can be reduced.

Although the present invention has been described in terms of the embodiment mentioned above, the present invention is not limited to this embodiment.

For example, although blood is mentioned as the measurement target in the above embodiment, urine may also be a measurement target. That is, the present invention also can be applied to sample processing systems that examine urine, and may be applied to clinical sample processing systems that examine other clinical specimens.

Although the collection unit 21 is disposed on the right side adjacent to the receiving unit 22 in the above embodiment, the present invention is not limited to this arrangement inasmuch as the collection unit 21 also may be disposed on the left side adjacent to the transport unit 34. Although the collection unit 21 is only a single unit within the sample processing system 1 in the above embodiment, the present invention is not limited to this arrangement inasmuch as multiple collection units may be deployed. The number and dispositions of each unit comprising the transport unit group may be variously modified as necessary.

Note that when the transport unit group within the sample processing system 1 is added to or modified from the layout shown in FIG. 1, the communication parts of the units added or modified are connected to the communication parts of the immediately adjacent units. Thus, additions and modifications to the layout of the transport unit group can be readily made since the adjacent unit can be connected via a short cable to enable communication. After addition or modification to the layout of the transport unit group, the individual units of the transport unit group and the transport controller 6 can communicate directly identical to the above embodiment.

The communication parts 212, 222, 232, A12, B12, C12, and 342 provided internally within the transport units 31, 32, 33, 34, and collection unit 21, receiving unit 22, and preprocessing unit 23 may be alternatively provided externally to these units.

The embodiment of the present invention may be variously modified insofar as such modification is within the scope of the technical ideas presented in the claims.

What is claimed is:

1. A sample processing apparatus, comprising:
at least one sample processing unit configured to process a sample;
a plurality of transport units connected in a row to transport a sample container containing a sample to the sample processing unit via each transport unit;
a transport control unit configured to control each transport unit, wherein each transport unit comprises:
a repeater connected to a first cable and a second cable, and capable of receiving transport control information transmitted from the transport control unit through the first cable and relaying the received transport control information to adjacent transport unit through the second cable; and
a controller capable of controlling a transport operation of the transport unit in response to the transport control information which has been received by the repeater through the first cable, and
the transport control unit is connected to the first cable of a predetermined transport unit, and is capable of communicating with the controller of a particular transport unit through each repeater between the transport control unit and the particular transport unit.

2. The sample processing apparatus of claim 1, wherein
the first cable connected to the transport control unit is connected only to the repeater of the predetermined transport unit among the plurality of transport units.

3. The sample processing apparatus of claim 1, wherein
the transport control information comprises destination information indicating the particular transport unit as a transmit destination, and
each repeater relays the transport control information in response to the destination information contained in the transport control information.

4. The sample processing apparatus of claim 3, wherein
the repeater and the controller in each transport unit are communicatably connected; and
the repeater of the particular transport unit corresponding to the destination indicated by the destination information transmits the transport control information to the controller in the particular transport unit.

5. The sample processing apparatus of claim 1, wherein
the controller in each transport unit is configured not to communicate with the controller of adjacent transport unit concerning transport control.

6. The sample processing apparatus of claim 1, wherein
the repeater is a switching hub for relaying the transport control information.

7. The sample processing apparatus of claim 6, wherein
the switching hub in each transport unit comprises an internal connection port for transmitting the transport control information received by the switching hub through the first cable to the controller in the same transport unit.

8. The sample processing apparatus of claim 7, wherein
the switching hub further comprises another internal connection port.

9. The sample processing apparatus of claim 1, wherein
at least one of the plurality of transport units is a processing transport unit configured to transport the sample container to a position where the sample processing unit holds the sample container to process the sample therein.

10. The sample processing apparatus of claim 9, wherein
at least one sample processing unit comprises a plurality of sample processing units, and the plurality of transport units comprise a plurality of processing transport units disposed in correspondence with the plurality of sample processing units;
the plurality of transport units comprise a container output unit configured to output the sample container to the processing transport unit on an uppermost upstream side in a direction of transport of the sample container; and
the transport control unit is connected to the first cable of the container output unit.

11. The sample processing apparatus of claim 1, wherein
at least one of the plurality of transport units is a container setting unit comprising a setting part on which a sample container is set by a user, and a transport mechanism for transporting the sample container set on the setting part to an adjacent transport unit.

12. The sample processing apparatus of claim 1, wherein
at least one of the plurality of transport units is a container collection unit for collecting sample containers that have undergone sample processing.

13. The sample processing apparatus of claim 1, wherein
the transport control unit transmits, to the controller of the particular transport unit, transport control information instructing to output the sample container to the transport unit adjacent to the particular transport unit,
the controller of the particular transport unit outputs the sample container from the particular transport unit to the adjacent transport unit in response to the transport control information, and transmits, to the transport control unit, output completion information indicating that the output has been completed, and
in response to the output completion information, the transport control unit transmits, to the controller of the adjacent transport unit, transport control information instructing to conduct a preparation for receiving the sample container outputted from the particular transport unit.

14. The sample processing apparatus of claim 13, wherein
at least one sample processing unit comprises a plurality of measurement units configured to measure a biological sample contained in the sample container;
the plurality of transport units comprise a plurality of measurement transport units disposed in correspondence with the plurality of measurement units, wherein the measurement transport unit is configured to transport the sample container to the corresponding measurement unit; and
the transport control unit determines a transport destination of the sample container among the plurality of measurement transport units based on a measurement order representing measurement items of the biological sample in the sample container, and transmits transport control information according to the determined transport destination.

15. The sample processing apparatus of claim 1, wherein
the plurality of transport units comprise a first transport unit and a second transport unit adjacent to the first transport unit, wherein the second transport unit is disposed on a downstream side of the first transport unit in a transport direction of the sample container, and
the second cable of the first transport unit is connected to the second transport unit as the first cable of the second transport unit.

16. A sample transporting device for transporting a sample container based on transport control information received from a transport control unit, the sample transporting device comprising:
a controller configured to control a transport operation of the sample transporting device in response to transport control information received from the transport control unit; and
a repeater connected to a first cable and a second cable, configured to receive the transport control information from the transport control unit through the first cable, and relay the transport control information to the controller when the received transport control information specifies the sample transporting device, or relay the transport control information to the second cable when the received transport control information specifies another sample transporting device.

17. The sample transport device of claim 16, wherein
the transport control information comprises destination information indicating the sample transporting device or the another sample transporting device as a transmit destination, and
the repeater is a switching hub for relaying the transport control information in response to the destination information contained in the transport control information.

18. The sample processing device of claim 16, further comprising
a transport mechanism configured to transport the sample container to a sample processing unit for processing the sample contained in the sample container.

19. The sample processing device of claim 16, further comprising
a container output mechanism configured to output the sample container to a transport line for transporting the transport container to the sample processing unit.

20. The sample processing device of claim 16, further comprising
a setting part on which a sample container is set by a user; and
a transport mechanism configured to transport the sample container set on the setting part to another sample transporting device.
